(19) United States
(12) Patent Application Publication
(10) Pub. No.: US 2024/0371357 A1
(43) Pub. Date: Nov. 7, 2024

(54) ADAPTIVE SPEECH REGENERATION

(71) Applicant: SHURE ACQUISITION HOLDINGS, INC., Niles, IL (US)

(72) Inventors: Daniel Law, Glencoe, IL (US); Bibo Gao, Buffalo Grove, IL (US); Mark Swiderski, Gurnee, IL (US)

(21) Appl. No.: 18/654,898

(22) Filed: May 3, 2024

Related U.S. Application Data
(60) Provisional application No. 63/500,164, filed on May 4, 2023.

(51) Int. Cl. G10L 13/02; G10L 15/04; G10L 15/26; G10L 25/30

(52) U.S. Cl. CPC G10L 13/02; G10L 15/04; G10L 15/26; G10L 25/30

(57) ABSTRACT

Embodiments provide for employing an audio transformation model to resynthesize speech signals associated with a speaking entity. Examples can receive audio signals comprising speech signals that are captured by an audio capture device. Examples can divide the audio signals into audio segments and input the audio segments into an audio transformation model to generate a voice vector representation and a speech vector representation. The voice vector representation comprises characteristics related to a speaking voice associated with the speaking entity and the speech vector representation comprises one or more words spoken by the speaking entity. The one or more words comprised in the speech vector representation are associated with respective contextual attributes associated with the one or more words. The audio transformation model can utilize the voice vector representation and the speech vector representation to regenerate the speech signals associated with the speaking entity.

### CROSS-REFERENCE TO RELATED APPLICATIONS

The present application claims priority to U.S. Provisional Application Ser. No. 63/500,164, titled “ADAPTIVE SPEECH REGENERATION,” filed May 4, 2023, the entire contents of which are incorporated herein by reference.

### TECHNICAL FIELD

Embodiments of the present disclosure relate generally to audio processing and, more particularly, to applying machine learning models to audio signals to regenerate speech signals associated with a speaking entity.

### BACKGROUND

Audio capture devices can be employed to capture speech signals from one or more speaking entities to facilitate communications such as, for example, a teleconference between two or more respective speaking entities. Through applied effort, ingenuity, and innovation, many identified deficiencies and problems have been solved by developing solutions that are configured in accordance with embodiments of the present disclosure, many examples of which are described herein.

### BRIEF SUMMARY

Various embodiments of the present disclosure are directed to apparatuses, systems, methods, and computer readable media for adaptive speech capture, encoding, decoding, and regeneration. These characteristics as well as additional features, functions, and details of various embodiments are described below. The claims set forth herein further serve as a summary of this disclosure.

### BRIEF DESCRIPTION OF THE DRAWINGS

Having thus described some embodiments in general terms, reference will now be made to the accompanying drawings, which are not necessarily drawn to scale, and wherein:

FIG. 1 illustrates an example audio signal processing system in accordance with one or more embodiments disclosed herein;

FIG. 2 illustrates an example audio processing apparatus configured in accordance with one or more embodiments disclosed herein;

FIGS. 3A and 3B illustrate a dataflow diagram for processing audio signal input for employment by an audio transformation model in accordance with one or more embodiments disclosed herein;

FIG. 4 illustrates an example method for adaptive speech capture, encoding, decoding, and regeneration in accordance with one or more embodiments disclosed herein; and

FIG. 5 illustrates another example method for adaptive speech capture, encoding, decoding, and regeneration in accordance with one or more embodiments disclosed herein.

### DETAILED DESCRIPTION

Various embodiments of the present disclosure will now be described more fully hereinafter with reference to the accompanying drawings, in which some, but not all embodiments of the present disclosure are shown. Indeed, the disclosure may be embodied in many different forms and should not be construed as limited to the embodiments set forth herein. Rather, these embodiments are provided so that this disclosure will satisfy applicable legal requirements.

### Overview

During a teleconference between two or more participants (e.g., a voice or video call), there are often sources of noise captured by the participants' respective communication or capture devices that interfere with the desired audio transmission (e.g., the speech of a respective participant on one end of the teleconference). This noise can include equipment noise in the conference room, reverberation in the conference room, other entities speaking in the background, paper rustling, typing, and/or the like. When these noise sources are present, it can be difficult or impossible for the respective participants to communicate effectively in a teleconference. Furthermore, digital signal processing techniques such as, for example, audio data compression, can introduce unwanted audio artifacts that can also make the desired audio transmission difficult to understand.

Furthermore, transmitting audio over long distances in real-time typically requires the audio data to be compressed. This compression is usually not lossless, which means the audio received on the far-end communication device is not the original, full-bandwidth audio that was recorded on the near-end communication device. This can be considered another source of noise as the audio data compression can sometimes create artifacts in the audio that can make the audio difficult or impossible to understand.

In order to address noise interference, traditional solutions attempt to apply digital signal processing techniques to the recorded audio to remove the noise or enhance the intended signal (e.g., a speaking voice of a teleconference participant). These signal processing techniques include noise reduction, echo cancellation, automatic gain control, EQ, de-reverberation and many others. However, these techniques are imperfect and often result in introducing other artifacts into the audio.

In order to address data compression, traditional solutions involve developing new audio CODECs to compress and/or decompress audio signals with less data loss. However, these solutions still involve compressing the audio signals (e.g., the intended speech signals of a respective teleconference participant as well as the residual noise in the room) into audio waveforms using a CODEC on the near-end communication device, transmitting the audio waveforms over a network, and then decompressing the audio waveforms on the far-end communication device. In such implementations, the residual noise and other audio artifacts generated by the audio signal processing techniques and/or audio compression are preserved in addition to the intended speech signals comprised in the original audio.

To address these and/or other technical problems associated with traditional teleconferencing systems, various embodiments disclosed herein provide for adaptively regenerating the speech of an end user (e.g., a teleconference participant) characterized by the respective voice of said end user. Rather than recording the acoustic signals on either end of a teleconference (e.g., which may include sources of noise), embodiments of the present disclosure employ an audio transformation model to extract and transmit both speech vector representations and voice vector representations. The speech vector representations may include a latent representation of speech (e.g., they may include speech primitives representative of the words spoken and how the words were spoken) and the voice vector representation, also referred to as an embedding or lower-dimensional representation, can capture nuances of the voice of the person or people speaking. Embodiments then transmit these respective voice and speech vector representations to another device such that the respective speech of a speaker can be regenerated in the speaker's voice by the other device.

Transmitting voice and speech vector representations rather than acoustic data inherently removes any sources of noise as the speech vector representations do not contain any acoustic noise and only contain the words that were spoken and how the words were spoken (e.g., a latent representation of speech). This means that the regenerated speech will only include the speech information and will be recreated in the speaker's voice in a high-quality audio format. Embodiments of the present disclosure therefore provide the technical benefit of providing a mechanism to pass speech communication with high intelligibility and low noise over a potentially bandwidth-limited channel, such as in a low-bandwidth voice or video conference.

Embodiments herein offer a multitude of technical benefits over traditional audio processing solutions. For instance, audio processing apparatuses herein employ improved techniques compared to traditional audio processing systems that use digital signal processing, such as audio data compression, to enhance communications. By extracting speech information (e.g., via generating a speech vector representation) that inherently removes any sources of extraneous noise and employing a voice vector representation to provide for regeneration of the speech of a speaking entity, audio processing apparatuses herein can deploy fewer memory resources that may be traditionally allocated to denoising, dereverberation, and/or other audio filtering for an audio signal.

Embodiments herein also provide the benefit of reducing bandwidth requirements and consumption. For example, the methods described herein offer bandwidth advantages over traditional CODECs. For instance, a traditional CODEC processing 22 KHz PCM audio at 16-bits uncompressed, requires 352 Kbps (e.g., 44.1 KB/sec). A typical CODEC (e.g., Zoom) recommends 60-100 Kbps for passing audio signals. Embodiments described herein can encapsulate speech in 688 Bytes per second, or 5.5 Kbps. Furthermore, embodiments herein require <10,000 bps of bandwidth as compared to existing solutions that consume up to 100,000 bps.

Moreover, a typical CODEC has test requirements for signal-to-noise-and-distortion ratio (SNDR). SNDR can be understood as the ratio of (i) the total signal (comprised of the desired signal (e.g., speech signals) plus the sum of all distortion and noise components) over (ii) the sum of all distortion and noise components. These test requirements, for example, may set an SNDR limit of about 40 dB for conferencing devices and can vary slightly depending on the type of device being tested (e.g., a headset microphone, ceiling array microphone, and/or the like). A typical CODEC may also have test requirements for frequency response. These test requirements may, for example, set a bandwidth limit of about 200 Hz-8 kHz. Because embodiments herein provide for digital regeneration of speech from voice vector representations and speech vector representations, embodiments herein can provide an SNDR>50 dB and a frequency response with a bandwidth limit of 20 Hz-20 KHz.

Embodiments herein also provide improved technical solutions over traditional audio processing technologies by applying machine learning models such as, for example, an audio transformation model, to generate low-bandwidth, low-noise communications with high audio fidelity (e.g., such as during a teleconference). That is, embodiments herein are configured to clone and/or otherwise model a speaking entity's speaking voice by generating a voice vector representation in real-time such as, for example, during a teleconference. Furthermore, embodiments herein can be configured to alter and/or replace the speaking voice of a particular speaking entity. For example, a speech vector representation associated with the speech of a first speaking entity can be utilized in combination with a voice vector representation associated with a second speaking entity. As such, the speech associated with the first speaking entity can be regenerated in the respective speaking voice of the second speaking entity.

### Exemplary Systems and Methods for Adaptive Speech Regeneration

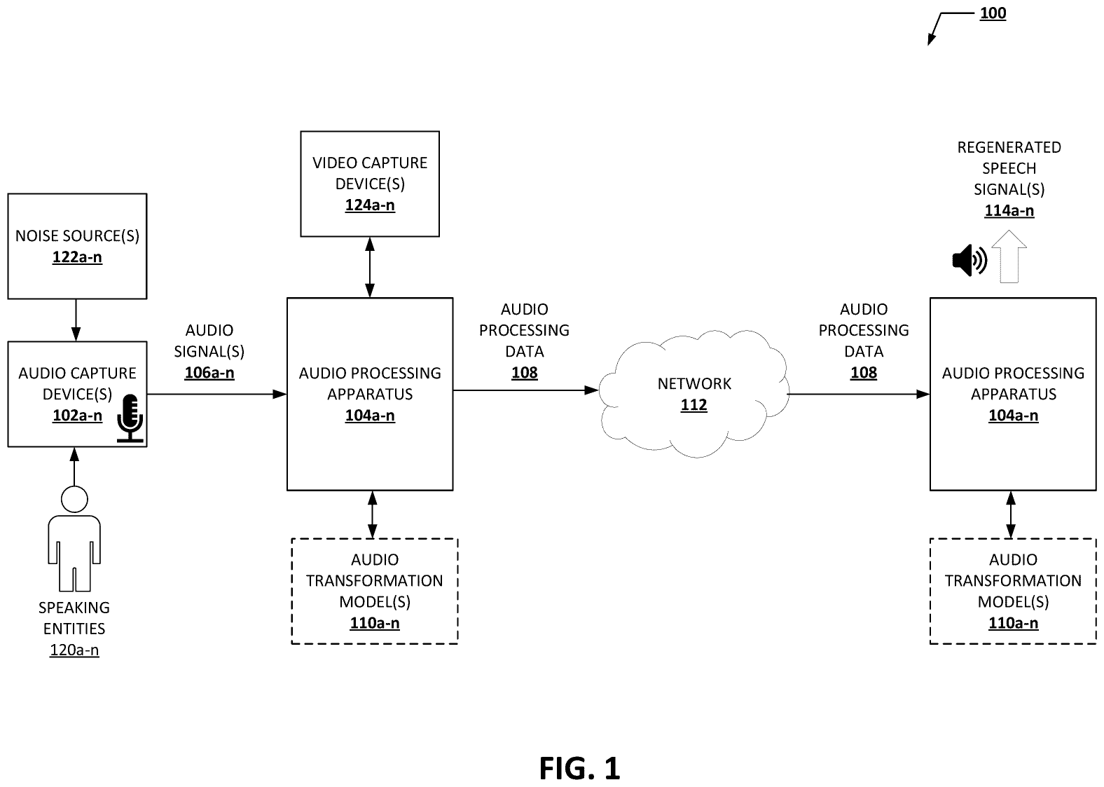

FIG. 1 illustrates an audio signal processing system 100 that is configured to provide adaptive speech capture, encoding, decoding, and regeneration for one or more speaking entities according to one or more embodiments of the present disclosure. The audio signal processing system 100 can be, for example, a conferencing system (e.g., a conference audio system, a video conferencing system, a digital conference system, etc.), an audio performance system, an audio recording system, a music performance system, a music recording system, a digital audio workstation, a lecture hall microphone systems, a broadcasting microphone system, an augmented reality system, a virtual reality system, an online gaming system, or another type of audio system. Additionally, the audio signal processing system 100 can be implemented as an audio signal processing apparatus and/or as software that is configured for execution on a smartphone, a laptop, a personal computer, a digital conference system, a wireless conference unit, an audio workstation device, an augmented reality device, a virtual reality device, a recording device, headphones, earphones, speakers, or another device.

The audio signal processing system 100 can include one or more audio capture device(s) 102a-n, one or more audio processing apparatus(es) 104a-n, one or more audio transformation model(s) 110a-n, a network 112, one or more speaking entities 120a-n, one or more noise source(s) 122a-n, and/or one or more video capture device(s) 124a-n. The one or more audio capture device(s) 102a-n can be a microphone, a video capture device, an infrared capture device, a sensor device, and/or any other type of audio capture device. A microphone can include, but is not limited to, a condenser microphone, a micro-electromechanical systems (MEMS) microphone, a dynamic microphone, a piezoelectric microphone, an array microphone, one or more beamformed lobes of an array microphone, a linear array microphone, a ceiling array microphone, a table array microphone, a virtual microphone, a network microphone, a ribbon microphone, an ambisonic microphone, or another type of microphones configured to capture audio.

The one or more speaking entities 120a-n can be one or more respective humans and the noise source(s) 122a-n can be one or more sources of extraneous noise other than the intended audio signals (e.g., the speech generated by one or more respective speaking entities 120a-n). Non-limiting examples of noise source(s) 122a-n can include office equipment generating extraneous noise in the conference room (e.g., computer keyboards, a printer, a fax machine, a coffee machine, and/or the like), reverberation and/or echoes generated by the conference room itself, other entities speaking or creating noise in the background, automobile traffic creating noise outside the building, and/or the like.

In an example where the one or more audio capture device(s) 102a-n include a microphone, the one or more audio capture device(s) 102a-n can be respectively configured for capturing audio by converting sound into one or more electrical signals. Audio captured by the one or more audio capture device(s) 102a-n can be converted into one or more audio signal(s) 106a-n. For example, audio captured by the one or more audio capture device(s) 102a-n can be converted into one or more audio signal(s) 106a-n generated by one or more speaking entities 120a-n (e.g., one or more participants in a teleconference). As such, the one or more audio signal(s) 106a-n can comprise one or more speech signals associated with a respective speaking entity (e.g., speaking entity 120a) of the one or more speaking entities 120a-n.

In some examples, a single audio capture device 102a can capture audio associated with two or more speaking entities 120a-n. In such a scenario, the audio signal(s) 106a-n may contain speech signals associated with the respective two or more speaking entities 120a-n. As such, an audio processing apparatus 104a associated with the single audio capture device 102a can be configured to separate the speech signals associated with the respective two or more speaking entities 120a-n in order to regenerate the speech signals in accordance with the methods described herein.

The one or more audio capture device(s) 102a-n can be positioned within a particular audio environment. In some examples, the one or more audio capture device(s) 102a-n can be integrated with, or embodied by, an audio processing apparatus (e.g., audio processing apparatus 104a). The audio signal(s) 106a-n can be configured as respective electrical signals and/or respective digital audio signals. In some examples, the audio signals 106a-n can be configured as respective signals including, but not limited to, radio frequency signals, optical signals, digital signals, analog signals and/or the like.

The one or more audio processing apparatus(es) 104a-n can employ audio transformation model(s) 110a-n to convert the one or more audio signals 106a-n into audio processing data 108 for transmitting over a network (e.g., network 112). The audio processing data 108 can comprise one or more of a voice vector representation, a speech vector representation, and/or one or more audio segments associated with the audio signal(s) 106a-n. The audio processing data 108 can be configured for regeneration of one or more speech signals comprised within the audio signal(s) 106a-n such that the speech signals are regenerated in the respective voice of one or more speaking entities 120a-n (e.g., one or more participants in a teleconference). Furthermore, the audio processing data 108 can comprise one or more streams of data such as, for example, one or more streams of audio data comprising one or more audio signals 106a-n, one or more voice vector representations, one or more speech vector representations, one or more portions of image data, and/or the like.

In some examples, the audio transformation model(s) 110a-n can be artificial intelligence (AI) models trained to perform one or more AI techniques and/or one or more machine learning (ML) techniques for regenerating speech signals in the respective speaking voice of one or more speaking entities 120a-n. The audio transformation model(s) 110a-n can be configured to capture, encode, decode, and/or regenerate one or more audio signals, and/or the audio transformation model(s) 110a-n can be configured to execute any combination of capturing, encoding, decoding, and/or regenerating of the one or more audio signals. In some examples, the audio transformation models 110a-n can be convolutional neural networks and/or recurrent neural networks. The audio transformation model(s) 110a-n can be configured as different types of deep neural networks. In some examples, a single audio transformation model 110a can comprise one or more discrete AI models configured to execute one or more respective ML techniques for capturing and encoding speech signals.

The audio transformation model(s) 110a-n may be configured to include or comprise parameters, hyper-parameters, and/or stored operations of a trained AI model that is configured to process a plurality of audio signals comprising one or more speech signals associated with a speaking entity 120a to generate a voice vector representation representative of a speaking voice associated with the speaking entity 120a. The audio transformation model(s) 110a-n may include artificial neural networks (ANNs), convolutional neural networks (CNNs), recurrent neural networks (RNNs), or any other type of specially trained neural networks that are configured to process the plurality of audio signals. The audio transformation model(s) 110a-n can be configured to determine one or more frequency patterns associated with the speaking voice of the speaking entity 120a. The audio transformation model(s) 110a-n can be configured to process each audio signal of the plurality of audio signals in a manner that leads to a predicted inference which determines how the one or more speech signals should be regenerated based on the one or more frequency patterns associated with the voice vector representation. In some examples, the audio transformation model(s) 110a-n can be configured to apply one or more digital signal processing (DSP) techniques to optimize the determination of the frequency patterns associated with the speaking voice of the speaking entity 120a.

The audio transformation model(s) 110a-n can also be trained to generate a speech vector representation of the words comprised in the speech signals as well as the manner in which the words were spoken. For example, the audio transformation model(s) 110a-n can be trained to extract one or more speech primitives comprising the one or more words spoken by the speaking entity 120a and convert the one or more speech primitives into a computer-readable format. The one or more speech primitives are one or more distinct portions of human speech generated by a respective speaking entity 120a (e.g., one or more respective spoken words and/or utterances) captured by the one or more audio device(s) 102a-n. The one or more speech primitives are converted into electronically managed representations (e.g., data objects) of the one or more respective words spoken by the speaking entity 120a and can be employed by the audio transformation model(s) 110a-n to regenerate (e.g., recreate and/or re-synthesize) one or more portions of human speech associated with the speaking entity 120a.

The audio transformation model(s) 110a-n can also be trained to determine one or more contextual attributes associated with the one or more speech primitives, where the one or more contextual attributes characterize the manner in which the one or more words were spoken. For example, the audio transformation model(s) 110a-n can be trained to detect one or more of vocal pitch, articulation, pause duration, pace, volume, intensity, and/or rate associated with the one or more words spoken by a respective speaking entity 120a. Additionally, the audio transformation model(s) 110a-n can be trained to detect one or more emotive qualities associated with the one or more words including, but not limited to, valence qualities, activation qualities, and/or dominance qualities. In some examples, the audio transformation model(s) 110a-n can be configured to apply one or more DSP techniques to optimize the extraction of the one or more speech primitives associated with the one or more words spoken by the speaking entity 120a.

In some examples, the audio transformation model(s) 110a-n can be trained as speech-to-text models and/or text-to-speech models. For example, a first audio transformation model 110a (e.g., associated with a first audio processing apparatus 104a) configured as a speech-to-text model can generate one or more portions of computer- and/or human-readable text associated with the words spoken by a particular speaking entity 120a. As such, a second audio transformation model 110b (e.g., associated with a second audio processing apparatus 104b) configured as a text-to-speech model can utilize the one or more portions of computer- and/or human-readable text in order to regenerate the speech of the particular speaking entity 120a in a speaking voice that is representative of the particular speaking entity 120a.

In some examples, the audio transformation model(s) 110a-n can embody, or integrate with, one or more computer vision model(s) configured to perform and/or augment the one or more methods described herein. For example, one or more audio processing apparatus(es) 104a-n can be associated with one or more respective video capture device(s) 124a-n. The one or more respective video capture device(s) 124a-n can be configured to capture image data associated with one or more speaking entities 120a-n during, for example, a communication session such as a teleconference. The audio transformation model(s) 110a-n embodying and/or integrating with the one or more computer vision model(s) can detect, based in part on the image data captured by the video capture device(s) 124a-n, various types of movement associated with one or more speaking entities 120a-n.

In some examples, the audio transformation model(s) 110a-n embodying and/or integrating with the one or more computer vision model(s) can be configured to detect head, facial, and/or mouth movements associated with one or more respective speaking entities 120a-n. In a scenario in which two or more speaking entities 120a-n are communicating via the same audio processing apparatus 104a, the audio transformation model(s) 110a-n embodying and/or integrating with the one or more computer vision model(s) can utilize the head, facial, and/or mouth movements associated with the two or more speaking entities 120a-n to determine which respective speaking entity is talking. As such, the audio transformation model(s) 110a-n can utilize the head, facial, and/or mouth movements to regenerate the speech signals associated with the two or more speaking entities 120a-n in the correct, corresponding speaking voice associated with the respective two or more speaking entities 120a-n.

In some examples, one or more portions of image data associated with a particular speaking entity 120a can be stored and/or associated with a voice vector representation corresponding to the particular speaking entity 120a. As such, the audio transformation model(s) 110a-n embodying and/or integrating with the one or more computer vision model(s) can recognize (e.g., via the video capture device(s) 124a-n) the particular speaking entity 120a and retrieve the voice vector representation associated with the particular speaking entity 120a in order to regenerate one or more speech signal(s) associated with the particular speaking entity 120a. In scenarios in which a voice vector representation has not been previously stored and/or associated with a particular speaking entity 120a (e.g., an additional, unrecognized speaking entity 120a enters the room during an ongoing communication session), the detection of one or more head, facial, and/or mouth movements by the audio transformation model(s) 110a-n embodying and/or integrating with the one or more computer vision model(s) can trigger the generation of a voice vector representation associated with the particular speaking entity 120a.

In some examples, the audio transformation model(s) 110a-n can be configured to detect one or more speaking entities 120a-n that are proximate to an audio processing apparatus 104a by employing one or more audio localization techniques to estimate a location of the one or more speaking entities 120a-n based upon the audio signal(s) 106a-n being generated by the one or more speaking entities 120a-n. For example, in an embodiment in which the audio processing apparatus 104a is associated with two or more audio capture device(s) 102a-n, the audio transformation model(s) 110a-n can analyze the respective audio signal(s) 106a-n captured by the two or more audio capture device(s) 102a-n to generate audio localization data associated with the speaking entities 120a-n. The audio localization data can be used to determine how many speaking entities 120a-n are nearby as well as estimate the locations of the speaking entities 120a-n. Furthermore, if the audio transformation model(s) 110a-n determine, based on the audio localization data, that a new speaking entity 120a has entered the room and/or has begun speaking, the audio transformation model(s) 110a-n can generate a voice vector representation associated with the new speaking entity 120a.

In some examples, the one or more audio signal(s) 106a-n, audio processing data 108, the one or more speech signals, one or more frequency patterns associated with the speaking voice of the speaking entity, the one or more speech primitives, the voice vector representation, the speech vector representation, one or more regenerated speech signal(s) 114a-n, one or more portions of image data captured by the video capture device(s) 124a-n, and/or one or more portions of audio localization data can be cached and/or otherwise stored in one or more datastores to be used as training data configured for training, re-training, and/or otherwise updating the audio transformation model(s) 110a-n. The training data can be stored in the memory 206 of an audio processing apparatus 104a. In various embodiments, the training data can be transmitted to and/or stored in an external server system. For instance, the audio processing apparatus 104a can transmit the training data via the network 112 to the external server system for storage and future model training and/or retraining purposes.

To facilitate the regeneration of speech signals comprised within the audio signal(s) 106a-n in the respective voice of one or more speaking entities 120a-n, the audio processing apparatus(es) 104a-n can divide the one or more respective audio signals 106a-n into one or more respective audio segments. In some examples, the respective audio segments generated by the audio processing apparatus(es) 104a-n can correspond to a predetermined duration. As a non-limiting example, the respective audio segments can be of a predetermined duration of one second. An audio processing apparatus (e.g., audio processing apparatus 104a) can input the one or more audio segments into the audio transformation model(s) 110a-n to generate both a voice vector representation of the respective speaking entity 120a and a speech vector representation comprising the one or more words spoken by the respective speaking entity 120a as well as information related to how the one or more words were spoken—also known as a latent representation of speech—by the respective speaking entity 120a.

An audio processing device (e.g., audio processing apparatus 104a) can transmit the audio processing data 108 comprising the voice vector representation and the speech vector representation over the network 112. Similarly, an audio processing device (e.g., audio processing apparatus 104b) can receive said audio processing data 108 via the network 112 and employ the audio transformation model(s) 110a-n to regenerate the speech signals contained within the audio processing data 108 in the respective voice of the speaking entity 120a associated with said speech signals. The audio processing device (e.g., audio processing apparatus 104b) can cause output of the regenerated speech signals (e.g., regenerated speech signals 114a-n).

In some examples, the network 112 is any suitable network or combination of networks and supports any appropriate protocol suitable for communication of data to and from one or more computing devices (e.g., one or more audio processing apparatus(es) 104a-n). The network 112 can include a public network (e.g., the Internet), a private network (e.g., a network within an organization), or a combination of public and/or private networks. The network 112 is configured to provide communication between various components depicted in FIG. 1. In some examples, network 112 comprises one or more networks that connect devices and/or components in the network layout to allow communication between the devices and/or components. For example, the network 112 is implemented as the Internet, a wireless network, a wired network (e.g., Ethernet), a local area network (LAN), a Wide Area Network (WANs), Bluetooth, Near Field Communication (NFC), or any other type of network that provides communications between one or more components of the network layout. The network 112 can be implemented using cellular networks, satellite, licensed radio, or a combination of cellular, satellite, licensed radio, and/or unlicensed radio networks.

It will be appreciated that various embodiments can be configured to perform all of the methods described herein via a single audio processing apparatus 104a associated with one or more audio transformation model(s) 110a-n. As such, the single audio processing apparatus 104a need not transmit audio processing data 108 generated based on any audio signal(s) 106a-n captured by corresponding audio capture device(s) 102a-n to any other computing device via the network 112, thus omitting the network 112 from such embodiments. For example, the single audio processing apparatus 104a can be configured to perform all of the methods described herein in order to regenerate one or more portions of speech signals associated with one or more speaking entities 120a-n.

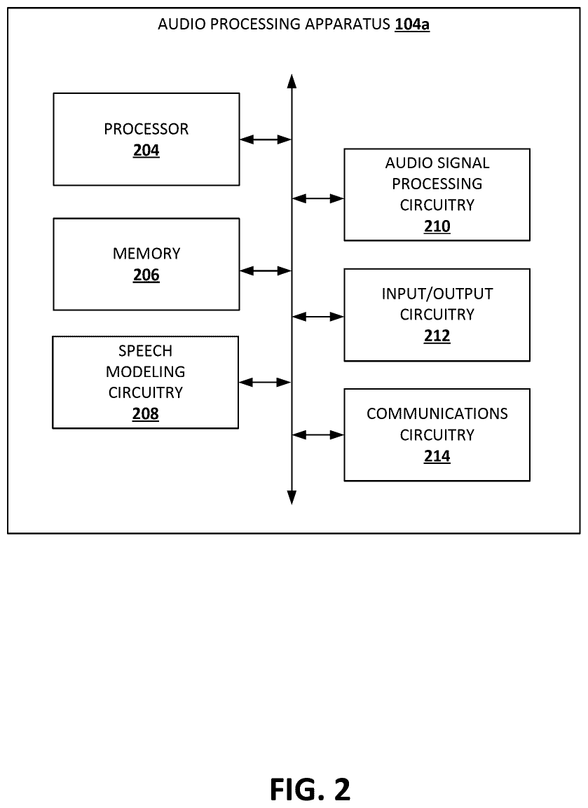

FIG. 2 illustrates an example audio processing apparatus 104a configured in accordance with one or more embodiments of the present disclosure. The audio processing apparatus 104s may be configured to perform one or more techniques described in FIG. 1 and/or one or more other techniques described herein.

In some examples, the audio processing apparatus 104a may be a computing system communicatively coupled with, and configured to control, one or more circuit modules associated with audio processing. For example, the audio processing apparatus 104a may be a computing system and/or a computing system communicatively coupled with one or more circuit modules related to audio processing. The audio processing apparatus 104a may comprise or otherwise be in communication with a processor 204, a memory 206, speech modeling circuitry 208, audio signal processing circuitry 210, input/output circuitry 212, and/or communications circuitry 214. In some examples, the processor 204 (which may comprise multiple or co-processors or any other processing circuitry associated with the processor) may be in communication with the memory 206.

The memory 206 may comprise non-transitory memory circuitry and may comprise one or more volatile and/or non-volatile memories. In some examples, the memory 206 may be an electronic storage device (e.g., a computer readable storage medium) configured to store data that may be retrievable by the processor 204. In some examples, the data stored in the memory 206 may comprise radio frequency signal data, audio data, stereo audio signal data, mono audio signal data, or the like, for enabling the apparatus to carry out various functions or methods in accordance with embodiments of the present disclosure, described herein.

In some examples, the processor 204 may be embodied in a number of different ways. For example, the processor 204 may be embodied as one or more of various hardware processing means such as a central processing unit (CPU), a microprocessor, a coprocessor, a DSP, an Advanced RISC Machine (ARM), a field programmable gate array (FPGA), a neural processing unit (NPU), a graphics processing unit (GPU), a system on chip (SoC), a cloud server processing element, a controller, or a processing element with or without an accompanying DSP. The processor 204 may also be embodied in various other processing circuitry including integrated circuits such as, for example, a microcontroller unit (MCU), an ASIC (application specific integrated circuit), a hardware accelerator, a cloud computing chip, or a special-purpose electronic chip. Furthermore, in some embodiments, the processor 204 may comprise one or more processing cores configured to perform independently. A multi-core processor may enable multiprocessing within a single physical package. The processor 204 may comprise one or more processors configured in tandem via the bus to enable independent execution of instructions, pipelining, and/or multithreading.

In some examples, the processor 204 may be configured to execute instructions, such as computer program code or instructions, stored in the memory 206 or otherwise accessible to the processor 204. The processor 204 may be configured to execute hard-coded functionality. As such, whether configured by hardware or software instructions, or by a combination thereof, the processor 204 may represent a computing entity (e.g., physically embodied in circuitry) configured to perform operations according to an embodiment of the present disclosure described herein. For example, when the processor 204 is embodied as an CPU, DSP, ARM, FPGA, ASIC, or similar, the processor may be configured as hardware for conducting the operations of an embodiment of the disclosure. Alternatively, when the processor 204 is embodied to execute software or computer program instructions, the instructions may specifically configure the processor 204 to perform the algorithms and/or operations described herein when the instructions are executed. However, in some examples, the processor 204 may be a processor of a device specifically configured to employ an embodiment of the present disclosure by further configuration of the processor using instructions for performing the algorithms and/or operations described herein. The processor 204 may further comprise a clock, an arithmetic logic unit (ALU) and logic gates configured to support operation of the processor 204, among other things.

In some examples, the audio processing apparatus 104 may comprise the speech modeling circuitry 208. The speech modeling circuitry 208 may be any means embodied in either hardware or a combination of hardware and software that is configured to perform one or more functions disclosed herein related to the audio transformation model(s) 110a-n. The audio processing apparatus 104 may comprise the audio signal processing circuitry 210. The audio signal processing circuitry 210 may be any means embodied in either hardware or a combination of hardware and software that is configured to perform one or more functions disclosed herein related to audio processing of the audio signal(s) 106a-n received from the one or more audio capture device(s) 102a-n and/or audio processing related to generation of one or more audio segments associated with the respective audio signal(s) 106a-n.

In some examples, the audio processing apparatus 104 may comprise the input/output circuitry 212 that may, in turn, be in communication with processor 204 to provide output to the user and, in some examples, to receive an indication of a user input. For example, the input/output circuitry 212 can integrate with, or embody, the one or more audio capture device(s) 102a-n. The input/output circuitry 212 may comprise a user interface and may comprise a display. In some examples, the input/output circuitry 212 may also comprise a keyboard, a touch screen, touch areas, soft keys, buttons, knobs, or other input/output mechanisms. The input/output circuitry 212 may also comprise or integrate with one or more speakers, array speakers, sound bars, headphones, earphones, in-ear monitors, and/or other listening devices capable of outputting one or more various audio signals (e.g., one or more regenerated speech signals).

In some examples, the audio processing apparatus 104 may comprise the communications circuitry 214. The communications circuitry 214 may be any means embodied in either hardware or a combination of hardware and software that is configured to receive and/or transmit data from/to a network (e.g., network 112) and/or any other device or module in communication with the audio processing apparatus 104. In this regard, the communications circuitry 214 may comprise, for example, an antenna or one or more other communication devices for enabling communications with a wired or wireless communication network. For example, the communications circuitry 214 may comprise antennae, one or more network interface cards, buses, switches, routers, modems, and supporting hardware and/or software, or any other device suitable for enabling communications via a network. The communications circuitry 214 may comprise the circuitry for interacting with the antenna/antennae to cause transmission of signals via the antenna/antennae or to handle receipt of signals received via the antenna/antennae.

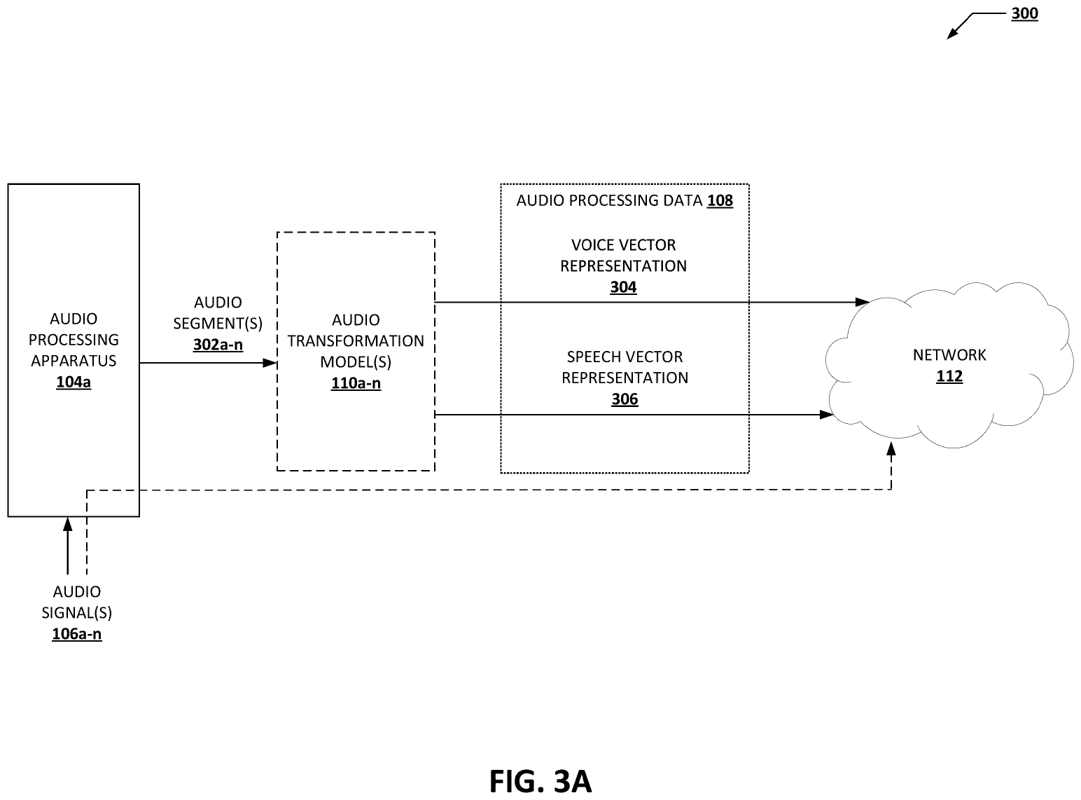

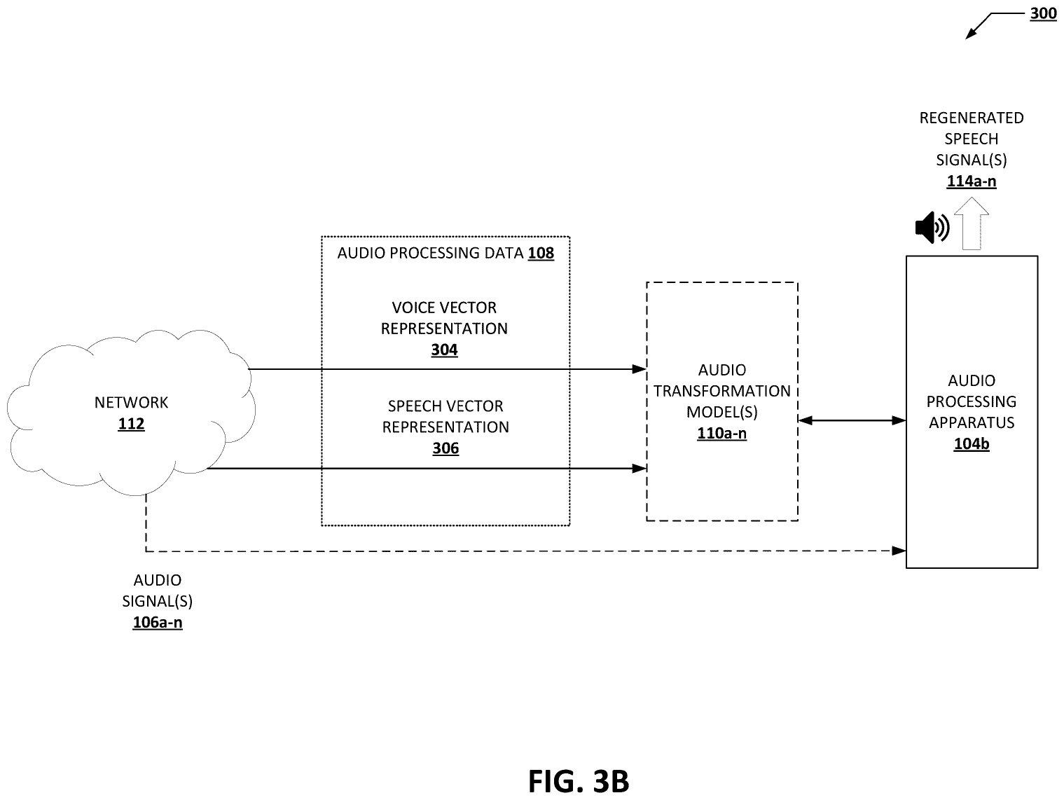

FIGS. 3A and 3B illustrate a dataflow diagram for processing audio signal input for employment by an audio transformation model according to one or more embodiments of the present disclosure. The dataflow diagram 300 comprises audio processing apparatuses 104a and 104b, the audio transformation model(s) 110a-n, and the network 112. The audio transformation model(s) 110a-n can be executed by the speech modeling circuitry 208 and/or another component of the audio processing apparatus (cs) 104a-n.

As depicted in FIG. 3A, the audio processing apparatus 104a can receive the one or more audio signals 106a-n (e.g., as captured by one or more audio capture device(s) 102a-n) comprising one or more speech signals associated with a particular speaking entity 120a (e.g., a participant in a teleconference). The audio processing apparatus 104a can be configured to perform one or more transformations with respect to the one or more audio signals 106a-n in order to generate one or more audio segment(s) 302a-n for employment by the audio transformation model(s) 110a-n. For example, the audio processing apparatus 104a can divide and/or otherwise process the one or more audio signal(s) 106a-n in order to generate the one or more audio segment(s) 302a-n. The one or more audio segment(s) 302a-n can correspond to a predetermined duration as set by the audio processing apparatus 104a and can be measured in any relevant unit of time (e.g., a combination of milliseconds, seconds, and/or the like).

The audio processing apparatus 104a can input the one or more audio segment(s) 302a-n into the audio transformation model(s) 110a-n. Based on one or more machine learning techniques, the audio transformation model(s) 110a-n can generate both a voice vector representation 304 and a speech vector representation 306 based on the one or more audio segment(s) 302a-n. The audio processing apparatus 104a can transmit the voice vector representation 304 and the speech vector representation 306 to the audio processing apparatus 104b via the network 112. In various embodiments, the audio processing apparatus 104a can compress, encrypt, and/or compile the voice vector representation 304 and the speech vector representation 306 into audio processing data 108 before transmitting the audio processing data 108 via the network 112.

The audio transformation model(s) 110a-n can generate a voice vector representation 304 representative of a speaking voice associated with a particular speaking entity 120a based on the first audio segment of the one or more audio segment(s) 302a-n. In various other embodiments, the audio transformation model(s) 110a-n can generate the voice vector representation 304 based on a predetermined number of audio segment(s) 302a-n, such as, for example, a predetermined number of audio segment(s) 302a-n totaling a predetermined duration of time. In this way, the embodiments described herein can generate a model of a speaking voice associated with a particular speaking entity 120a in near real-time during a communication session (e.g., during a teleconference).

However, it will be appreciated that a voice vector representation 304 can be generated on-demand. For example, a voice vector representation 304 can be generated for a particular speaking entity 120a during an initialization of an audio processing apparatus 104a and/or computer application that utilizes the methods described herein. As such, a voice vector representation 304 associated with a speaking entity 120a that was generated previously can be sent to a second audio processing apparatus 104b at the start of a teleconference. In this regard, in some embodiments, a voice vector representation 304 can be generated before a communication session (e.g., a teleconference) is initiated. It will also be appreciated that a voice vector representation 304 associated with a particular speaking entity 120a can be generated based on pre-recorded audio signal(s) 106a-n. For example, in various embodiments, rather than capturing new audio signal(s) 106a-n associated with the particular speaking entity 120a from one or more audio capture device(s) 102a-n, an audio processing apparatus 104a can ingest one or more pre-recorded audio signals(s) 106a-n associated with the particular speaking entity 120a to employ for generating the voice vector representation 304.

It will be appreciated that, in some examples, when a communication session such as a teleconference is initiated, the audio processing apparatus(es) 104a-n can be configured to employ traditional CODECs until the voice vector representation 304 has been successfully generated. Upon successful generation of the voice vector representation 304, the audio processing apparatus (cs) 104a-n can then switch from using traditional CODECs into using the adaptive speech capture, encoding, decoding, and regeneration methods described herein.

The generation of the voice vector representation 304 by the audio transformation model(s) 110a-n comprises determining one or more frequency patterns related to the speaking voice associated with the respective speaking entity 120a (e.g., a respective participant in a teleconference). The audio transformation model(s) 110a-n are configured to analyze one or more waveforms associated with one or more speech signals associated with the respective speaking entity 120a to determine the one or more of frequency patterns related to the speaking voice of the speaking entity 120a. In some embodiments, the audio transformation model(s) 110a-n are configured to analyze one or more spectrograms associated with the speech signals in order to determine the one or more frequency patterns of the speaking voice related to the speaking entity 120a. The frequency patterns comprised within the voice vector representation 304 are used to recreate the nuances and characterizations of the unique speaking voice of the respective speaking entity 120a such that when the speech signals comprised in the one or more audio signal(s) 106a-n are regenerated by the audio transformation model(s) 110a-n, the speech signals are regenerated in the respective voice of the speaking entity 120a.

In some examples, the voice vector representation 304 is generated and transmitted only once during a single communication session (e.g., a teleconference). For example, once the audio transformation model(s) 110a-n generates the voice vector representation 304 associated with a respective speaking entity, the audio processing apparatus 104a transmits the voice vector representation 304 to the audio processing apparatus 104b only once. The voice vector representation 304 can be embedded in the audio processing apparatus 104b for the duration of the single communication session and repeatedly employed for regenerating the speech of the respective speaking entity 120a associated with the voice vector representation 304. In some circumstances, the voice vector representation 304 can be generated and transmitted multiple times during a single communication session. For example, a speaking entity 120a associated with the voice vector representation 304 may generate a request (e.g., via the audio processing apparatus 104a) to update and/or regenerate the voice vector representation 304. In such circumstances, once a voice vector representation 304 has been updated and/or regenerated, the voice vector representation 304 can be retransmitted (e.g., transmitted a second time) to the audio processing apparatus 104b.

In some examples, the voice vector representation 304 can be cached and/or otherwise permanently stored in the memory (e.g., memory 206) of an audio processing apparatus (e.g., audio processing apparatus 104b) for employment in future communication sessions with the same speaking entity 120a associated with the voice vector representation 304. For example, a particular voice vector representation 304 can be associated with a respective user profile related to a particular speaking entity 120a and stored on one or more audio processing apparatus(es) 104a-n for use in future communication sessions with the respective speaking entity 120a. Furthermore, image data (e.g., captured by the video capture device(s) 124a-n) associated with a particular speaking entity 120a can be stored in the memory (e.g., memory 206) and employed by the audio transformation model(s) 110a-n to determine the voice vector representation 304 associated the particular speaking entity 120a.

The audio transformation model(s) 110a-n are also configured to generate a speech vector representation 306 based on the one or more audio segment(s) 302a-n. Generation of the speech vector representation 306 by the audio transformation model(s) 110a-n comprises extracting one or more speech primitives comprising the one or more words spoken by a speaking entity 120a where the one or more speech primitives are converted into a computer-readable format. The one or more speech primitives associated with the speech vector representation 306 not only comprise the one or more respective words spoken by the respective speaking entity, but also the manner in which the one or more words were spoken. In this regard, the one or more speech primitives comprised within the speech vector representation 306 are associated with one or more contextual attributes characterizing the manner in which the one or more words were spoken. The one or more contextual attributes are associated with one or more acoustic features, emotive qualities, and/or speech delivery characteristics related to the one or more respective speech signals associated with the one or more speech primitives.

The one or more contextual attributes include, but are not limited to, attributes related to one or more acoustic features such as pitch, articulation, volume, and intensity, as well as one or more speech delivery characteristics such as pause duration, pace, and/or speech rate associated with the one or more words spoken by a respective speaking entity 120a. Furthermore, the one or more speech primitives associated with the one or more spoken words comprised in the speech vector representation 306 can be characterized by one or more emotive qualities. For example, the audio transformation model(s) 110a-n can derive various emotive qualities associated with the one or more words comprised in the one or more audio segment(s) 302a-n.

The emotive qualities of the spoken words can be measured and/or categorized according to various emotional dimensions including, but not limited to, valence, activation, and dominance. Valence is associated with pleasure and captures a range of happiness/unhappiness when a speaking entity 120a expresses a pleasant or unpleasant feeling about a topic. Activation, also known as affective activation, represents a scope of arousal of the speaking entity 120a ranging from sleep to excitement. Dominance, which reflects the level of control the speaking entity 120a has over an emotional state, ranges from weak/submissive to strong/dominant. The audio transformation model(s) 110a-n are configured to capture these contextual attributes and emotive qualities while generating the speech vector representation 306 so that the speaking entity's affect, emotions, and speech delivery are fully captured when the speech signals associated with the speaking entity 120a are ultimately regenerated for output by one or more audio processing apparatus(es) 104a-n (e.g., regenerated speech signals 114a-n output by the corresponding input/output circuitry 212).

As depicted in FIG. 3B, the audio processing apparatus 104a can transmit the audio processing data 108 comprising the voice vector representation 304 and the speech vector representation 306 to the audio processing apparatus 104b via the network 112. The audio processing apparatus 104b can receive said audio processing data 108 and employ the audio transformation model(s) 110a-n to regenerate the speech signals contained within the audio processing data 108 in the respective voice of the speaking entity 120a associated with said speech signals. The audio processing apparatus 104b can cause output of the regenerated speech signals 114a-n.

In some examples, the audio processing apparatus 104a can transmit, in near real-time, the one or more audio signal(s) 106a-n captured by the one or more audio capture device(s) 102a-n for outputting of the one or more audio signal(s) 106a-n by the audio processing apparatus 104b. Additionally, the audio processing apparatus 104b can generate a live text transcript of the speech signals comprised within the one or more audio signal(s) 106a-n. The live text transcript can be used alone, or in combination with the audio processing data 108, to regenerate the speech signals associated with the live text transcript. For example, the audio transformation model(s) 110a-n can supplement the audio processing data 108 with the live text transcript in order to enhance the regeneration of the speech signals. The audio processing apparatus 104b can simultaneously play, or “layer,” the audio signal(s) 106a-n with the regenerated speech signals 114a-n as the regenerated speech signals 114a-n are outputted by the audio processing apparatus 104b in order to enhance the experience of an end user.

Furthermore, it will be appreciated that the audio processing apparatus(es) 104a-n can transmit the speech vector representation 306 along with a traditional audio data compression mechanism in order to improve the audio signal(s) 106a-n on the far end of a teleconference (e.g., at audio processing apparatus 104b). In some examples, the speech vector representation 306 can be used to fill in gaps in the speech signals comprised in the audio signal(s) 106a-n.

It will also be appreciated that the speech vector representation 306 can be used to improve various digital signal processing (DSP) algorithms. For example, the speech vector representation 306 can be used to improve a DSP algorithm configured for echo cancellation. As the speech vector representation 306 has a multitude of data related to the intended audio signals (e.g., the intended speech of a particular speaking entity 120a), a comparison could be made between the speech vector representation 306 and any audio data related to an echo in the environment (e.g., a room, studio, concert hall, and/or the like) that was captured by the audio capture device(s) 102a-n. In this way, the speech vector representation 306 can be used to further isolate the intended audio signals (e.g., the intended speech) from any echoes captured at the same time. It will be appreciated that a similar improvement can be made to a DSP algorithm configured to reduce noise from an audio signal. For example, the speech vector representation 306 can be used to further isolate the intended audio signals (e.g., the intended speech) from extraneous noise associated with the audio signal(s) 106a-n.

While FIGS. 3A and 3B serve illustrate the dataflows and methods described herein with reference to two audio processing apparatuses 104a and 104b, it will be appreciated that the methods described herein can be performed by more than two audio processing apparatuses simultaneously. For example, in an instance in which the methods described herein are being applied during a teleconference between three or more speaking entities 120a-n, the audio processing apparatus 104a may transmit audio processing data 108 comprising one or more of a voice vector representation 304 and/or a speech vector representation 306, and/or one or more audio signal(s) 106a-n to two or more audio processing apparatuses 104b-n during a communication session.

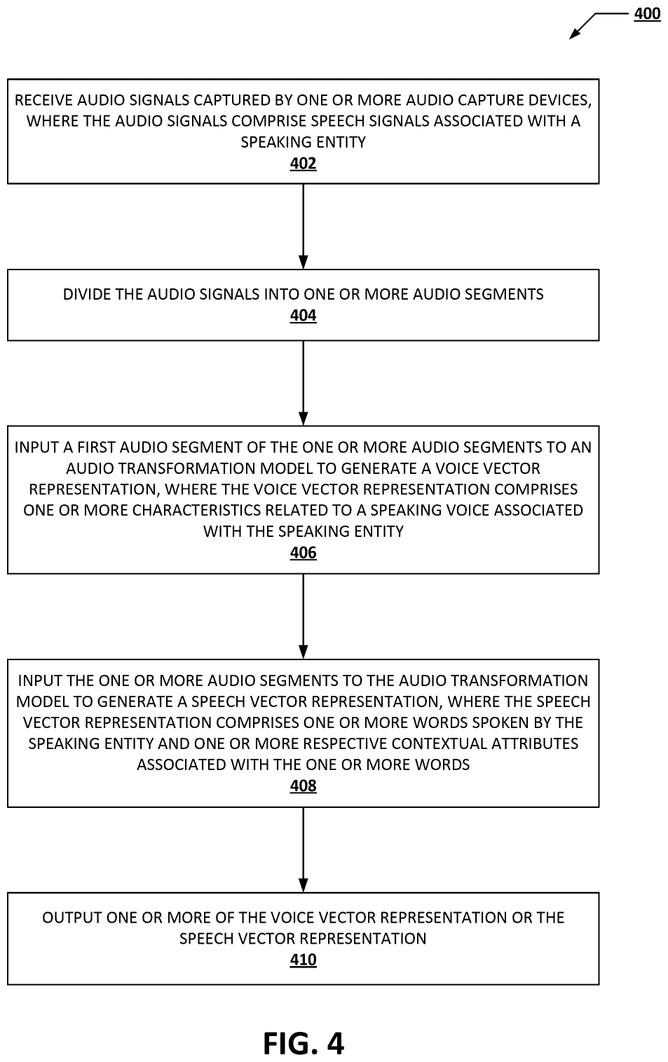

FIG. 4 is a flowchart diagram of an example process 400, for providing adaptive speech capture, encoding, decoding, and regeneration, in accordance with, for example, an audio processing apparatus 104a illustrated in FIG. 2. Via the various operations of the process 400, the audio processing apparatus 104a can facilitate high quality, low bandwidth communications with one or more other audio processing apparatuses (e.g., audio processing apparatus(es) 104b-n) via a network (e.g., network 112). The process 400 begins at operation 402 that receives (e.g., by the communications circuitry 214) audio signals captured by one or more audio capture devices, where the audio signals comprise speech signals associated with a speaking entity 120a. For example, the audio processing apparatus 104a can receive one or more audio signal(s) 106a-n from one or more audio capture device(s) 102a-n associated with a particular speaking entity 120a (e.g., a participant in a teleconference).

The process 400 also includes an operation 404 that divides (e.g., by the audio signal processing circuitry 210) the audio signals into one or more audio segments. For example, the audio processing apparatus 104a can divide the audio signal(s) 106a-n into one or more audio segment(s) 302a-n which can correspond to a predetermined duration as set by the audio processing apparatus 104a and can be measured in any relevant unit of time (e.g., a combination of milliseconds, seconds, and/or the like).

The process 400 also includes an operation 406 that inputs a first audio segment of the one or more audio segments to an audio transformation model (e.g., audio transformation model(s) 110a-n) to generate a voice vector representation (e.g., by the speech modeling circuitry 208), where the voice vector representation comprises one or more characteristics related to a speaking voice associated with the speaking entity 120a. For example, the audio processing apparatus 104a can employ the audio transformation model(s) 110a-n to generate the voice vector representation 304 based on a predetermined number of audio segment(s) 302a-n, such as, for example, a predetermined number of audio segment(s) 302a-n totaling a predetermined duration of time.

The process 400 also includes an operation 408 that inputs the one or more audio segments to the audio transformation model (e.g., audio transformation model(s) 110a-n) to generate a speech vector representation (e.g., by the speech modeling circuitry 208), where the speech vector representation comprises one or more words spoken by the speaking entity 120a and one or more respective contextual attributes associated with the one or more words. For example, the audio processing apparatus 104a can employ the audio transformation model(s) 110a-n to generate the speech vector representation 306 based on the one or more audio segment(s) 302a-n. Operation 408 comprises extracting one or more speech primitives comprising the one or more words spoken by a speaking entity 120a where the one or more speech primitives are converted into a computer-readable format. The speech vector representation 306 not only comprises the one or more speech primitives comprising the one or more respective words spoken by the respective speaking entity, but also the manner in which the one or more words were spoken. In this regard, the one or more speech primitives comprised within the speech vector representation 306 are associated with one or more contextual attributes characterizing the manner in which the one or more words were spoken.

The process 400 also includes an operation 410 that outputs (e.g., by the communications circuitry 214) one or more of the voice vector representation or the speech vector representation. For example, the audio processing apparatus 104a can transmit the voice vector representation 304 and/or the speech vector representation 306 to one or more other audio processing apparatus(es) 104b-n. The audio transformation model(s) 110a-n of the one or more other audio processing apparatus(es) 104b-n can regenerate the speech signals (e.g., regenerated speech signal(s) 114a-n) associated with the speech vector representation 306 in the respective voice of the speaking entity 120a associated with the voice vector representation 304. The audio processing apparatus(es) 104b-n can output the regenerated speech signal(s) 114a-n via one or more speakers, array speakers, sound bars, headphones, earphones, in-ear monitors, and/or other listening devices integrated with the input/output circuitry 212.

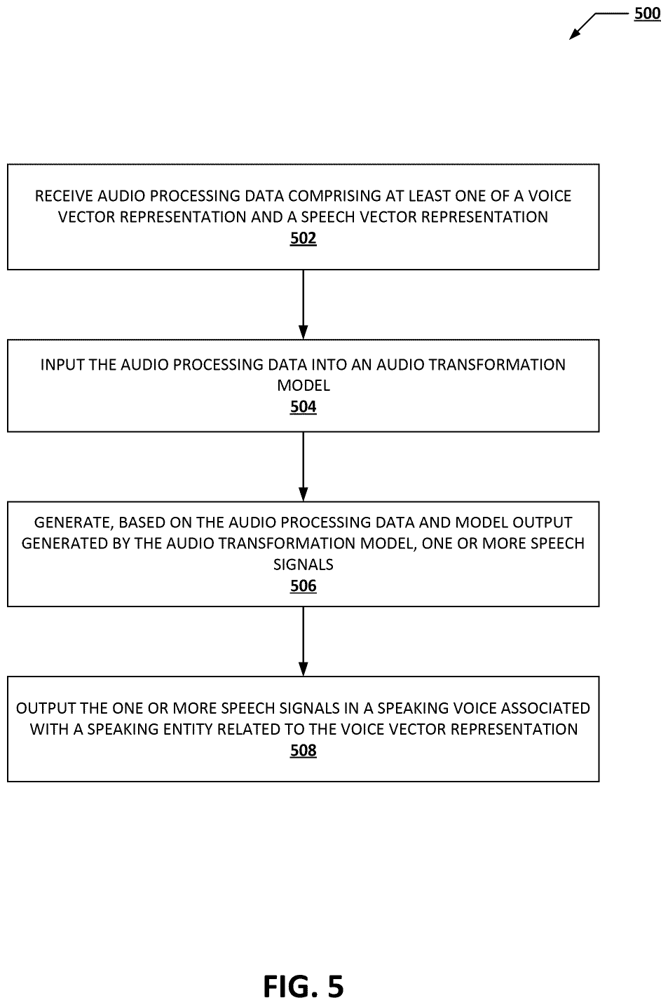

FIG. 5 is a flowchart diagram of an example process 500, for providing adaptive speech capture, encoding, decoding, and regeneration, in accordance with, for example, an audio processing apparatus 104a illustrated in FIG. 2. The process 500 begins at operation 502 that receives (e.g., by the communications circuitry 214) audio processing data comprising at least one of a voice vector representation and a speech vector representation. For example, the audio processing apparatus 104b can receive audio processing data 108 from the audio processing apparatus 104a associated with a particular speaking entity 120a (e.g., a participant in a teleconference) via the network 112. The audio processing data 108 can comprise at least one voice vector representation 304, where the voice vector representation 304 comprises one or more characteristics related to a speaking voice associated with the speaking entity 120a. The audio processing data 108 can also comprise at least one speech vector representation 306, where the speech vector representation comprises one or more words spoken by the speaking entity 120a and one or more respective contextual attributes associated with the one or more words.

The process 500 also includes an operation 504 that inputs the audio processing data 108 comprising the voice vector representation 304 and the speech vector representation 306 to an audio transformation model (e.g., audio transformation model(s) 110a-n). The process 500 also includes an operation 506 that generates, based on the audio processing data 108 and model output generated by the audio transformation model(s) 110a-n, one or more speech signals. For example, the audio processing apparatus 104b can employ the audio transformation model(s) 110a-n to generate the one or more speech signals associated with the speech vector representation 306 based on one or more speech primitives comprising one or more words spoken by the speaking entity 120a comprised within the speech vector representation 306.

The process 500 also includes an operation 508 that outputs the one or more speech signals in a speaking voice associated with the speaking entity related to the voice vector representation. For example, the audio processing apparatus 104b can employ the audio transformation model(s) 110a-n to output the one or more speech signals in a voice characterized by the speaking voice associated with the speaking entity 120a comprised in the voice vector representation 304 (e.g., regenerated speech signal(s) 114a-n). The audio processing apparatus 104b can output the regenerated speech signal(s) 114a-n via one or more speakers, array speakers, sound bars, headphones, earphones, in-ear monitors, and/or other listening devices integrated with the input/output circuitry 212.

It will be appreciated that embodiments of the present disclosure are not limited to the regeneration of speech signals associated with one or more speaking entities 120a-n. Although the primary example embodiments and methods described herein pertain mainly to one or more speaking entities 120a-n generating audio signal(s) 106a-n comprising respective speech signals, the audio processing apparatus(es) 104a-n and corresponding audio transformation model(s) 110a-n can be configured to regenerate audio signal(s) 106a-n generated by various other sources. A non-limiting example of the various types of sources that can produce audio signal(s) 106a-n to be regenerated by an audio processing apparatus 104a include musical instruments. For example, embodiments of the present disclosure can be configured to regenerate audio signal(s) 106a-n produced by one or more guitars, keyboards, drums, horns, instrument pickups (e.g., piezo pickups), microphones, and/or the like. As such, the one or more audio transformation model(s) 110a-n can be configured to generate vector representations associated with the one or more respective types of musical instruments listed above such that the respective vector representations of the musical instruments can be employed by one or more audio processing apparatus(es) 104a-n to regenerate audio signal(s) 106a-n produced by the respective musical instruments.

Embodiments of the present disclosure are described with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time.

In some example embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

Although example processing systems have been described in the figures herein, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, e.g., one or more modules of computer program instructions, encoded on computer-readable storage medium for execution by, or to control the operation of, information/data processing apparatus. Alternatively, or in addition, the program instructions can be encoded on an artificially generated propagated signal, e.g., a machine-generated electrical, optical, or electromagnetic signal, which is generated to encode information/data for transmission to suitable receiver apparatus for execution by an information/data processing apparatus. A computer-readable storage medium can be, or be included in, a computer-readable storage device, a computer-readable storage substrate, a random or serial access memory array or device, or a combination of one or more of them. Moreover, while a computer-readable storage medium is not a propagated signal, a computer-readable storage medium can be a source or destination of computer program instructions encoded in an artificially generated propagated signal. The computer-readable storage medium can also be, or be included in, one or more separate physical components or media (e.g., multiple CDs, disks, or other storage devices).

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random-access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

The term “or” is used herein in both the alternative and conjunctive sense, unless otherwise indicated. The terms “illustrative,” “example,” and “exemplary” are used to be examples with no indication of quality level. Like numbers refer to like elements throughout.

The term “comprising” means “including but not limited to,” and should be interpreted in the manner it is typically used in the patent context. Use of broader terms such as comprises, includes, and having should be understood to provide support for narrower terms, such as consisting of, consisting essentially of, comprised substantially of, and/or the like.

The phrases “in one embodiment,” “according to one embodiment,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

While this specification contains many specific implementation details, these should not be construed as limitations on the scope of any disclosures or of what may be claimed, but rather as description of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a product or packaged into multiple products.

Hereinafter, various characteristics will be highlighted in a set of numbered clauses or paragraphs. These characteristics are not to be interpreted as being limiting on the disclosure or inventive concept, but are provided merely as a highlighting of some characteristics as described herein, without suggesting a particular order of importance or relevancy of such characteristics.

Clause 1. An audio processing apparatus comprises at least one processor and a memory storing instructions that are operable, when executed by the at least one processor, to cause the audio processing apparatus to receive audio signals captured by one or more audio capture devices, wherein the audio signals comprise one or more first speech signals associated with a first speaking entity, divide the audio signals into one or more audio segments, input a first audio segment of the one or more audio segments to a first audio transformation model to generate a first voice vector representation, wherein the first voice vector representation comprises one or more characteristics related to a first speaking voice associated with the first speaking entity, input the one or more audio segments to the first audio transformation model to generate a first speech vector representation, wherein the first speech vector representation comprises one or more words spoken by the first speaking entity and one or more respective contextual attributes associated with the one or more words, and output one or more of the first voice vector representation or the first speech vector representation.

Clause 2. An audio processing apparatus according to the foregoing Clause, wherein the first audio transformation model comprises a neural network.

Clause 3. An audio processing apparatus according to any of the foregoing Clauses, wherein the instructions are operable, when executed by the at least one processor, to further cause the audio processing apparatus to, prior to inputting the one or more audio segments to the first audio transformation model, extract the one or more words spoken by the first speaking entity from the one or more audio segments and convert the one or more words into a computer-readable format.

Clause 4. An audio processing apparatus according to any of the foregoing Clauses, wherein the first audio transformation model is configured to generate the first speech vector representation based on one or more speech primitives associated with the one or more words spoken by the first speaking entity and the one or more respective contextual attributes associated with the one or more words.

Clause 5. An audio processing apparatus according to any of the foregoing Clauses, wherein the one or more respective contextual attributes comprise at least one of one or more acoustic features, one or more emotive qualities, or one or more speech delivery characteristics associated with the one or more words spoken by the first speaking entity.

Clause 6. An audio processing apparatus according to any of the foregoing Clauses, wherein the one or more acoustic features comprise at least one of pitch, articulation, volume, or intensity.

Clause 7. An audio processing apparatus according to any of the foregoing Clauses, wherein the one or more speech delivery characteristics comprise at least one of pause duration, pace, or speech rate.

Clause 8. An audio processing apparatus according to any of the foregoing Clauses, wherein the one or more emotive qualities are characterized by one or more respective emotional dimensions, wherein the one or more respective emotional dimensions comprise at least one of valence, activation, or dominance.

Clause 9. An audio processing apparatus according to any of the foregoing Clauses, wherein the first speech vector representation and the first voice vector representation are configured for regeneration of the one or more first speech signals associated with the first speaking entity by a second audio processing apparatus.

Clause 10. An audio processing apparatus according to any of the foregoing Clauses, wherein the instructions are further operable to cause the audio processing apparatus to transmit, in near real-time, the audio signals captured by the one or more audio capture devices to a second audio processing apparatus for outputting of the audio signals by the second audio processing apparatus.

Clause 11. An audio processing apparatus according to any of the foregoing Clauses, wherein the audio signals are configured for generating, at the second audio processing apparatus, a live text transcript representative of the one or more first speech signals associated with the first speaking entity.

Clause 12. An audio processing apparatus according to any of the foregoing Clauses, wherein the live text transcript is configured for regeneration of the one or more first speech signals associated with the first speaking entity at the second audio processing apparatus, and wherein the regeneration of the one or more first speech signals is executed at the second audio processing apparatus simultaneously with the outputting of the audio signals by the second audio processing apparatus.

Clause 13. An audio processing apparatus according to any of the foregoing Clauses, wherein the one or more audio segments correspond to a predetermined duration of time.

Clause 14. An audio processing apparatus according to any of the foregoing Clauses, wherein the instructions are further operable to cause the audio processing apparatus to encrypt both the first voice vector representation and the first speech vector representation.

Clause 15. An audio processing apparatus according to any of the foregoing Clauses, wherein the instructions are further operable to cause the audio processing apparatus to compress at least one of the first speech vector representation or the first voice vector representation.

Clause 16. An audio processing apparatus according to any of the foregoing Clauses, wherein the instructions are further operable to cause the audio processing apparatus to capture, via one or more video or image capture devices, one or more portions of image data, wherein the one or more portions of image data are associated with the first speaking entity.

Clause 17. An audio processing apparatus according to any of the foregoing Clauses, wherein the first voice vector representation associated with the first speaking entity is generated based on capturing the one or more portions of image data associated with the first speaking entity.

Clause 18. An audio processing apparatus according to any of the foregoing Clauses, wherein the first audio transformation model is further configured to generate one or more portions of audio localization data associated with the first speaking entity, wherein the one or more portions of audio localization data comprises an estimated location of the first speaking entity relative to the audio processing apparatus.

Clause 19. An audio processing apparatus according to any of the foregoing Clauses, wherein the first voice vector representation associated with the first speaking entity is generated based on the audio localization data.

Clause 20. An audio processing apparatus according to any of the foregoing Clauses, wherein the instructions are further operable to cause the audio processing apparatus to receive a second voice vector representation, receive a second speech vector representation, input the second voice vector representation and the second speech vector representation into a second audio transformation model, generate, based on the second voice vector representation, the second speech vector representation, and model output generated by the second audio transformation model, one or more second speech signals, and output the one or more second speech signals in a second speaking voice associated with a second speaking entity related to the second voice vector representation.

Clause 21. A computer-implemented method comprising the steps of any of the foregoing Clauses.

Clause 22. A computer program product, stored on a computer readable medium and comprising instructions that, when executed by one or more processors, cause the one or more processors to perform the steps of any of the foregoing Clauses.

Clause 23. An audio processing apparatus comprises at least one processor and a memory storing instructions that are operable, when executed by the at least one processor, to cause the audio processing apparatus to receive audio signals captured by one or more audio capture devices, wherein the audio signals comprise speech signals associated with a speaking entity, input the audio signals to a model, wherein the model is configured to generate a voice vector representation, wherein the voice vector representation is representative of one or more characteristics related to a speaking voice associated with the speaking entity, input the audio signals to the model, wherein the model is configured to generate a speech vector representation, wherein the speech vector representation comprises one or more words spoken by the speaking entity, and wherein the one or more words are associated with one or more respective contextual attributes, and output one or more of the voice vector representation or the speech vector representation.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

1. An audio processing apparatus comprising at least one processor and a memory storing instructions that are operable, when executed by the at least one processor, to cause the audio processing apparatus to:
receive audio signals captured by one or more audio capture devices, wherein the audio signals comprise one or more first speech signals associated with a first speaking entity;
divide the audio signals into one or more audio segments;
input a first audio segment of the one or more audio segments to a first audio transformation model to generate a first voice vector representation, wherein the first voice vector representation comprises one or more characteristics related to a first speaking voice associated with the first speaking entity;
input the one or more audio segments to the first audio transformation model to generate a first speech vector representation, wherein the first speech vector representation comprises one or more words spoken by the first speaking entity and one or more respective contextual attributes associated with the one or more words; and
output one or more of the first voice vector representation or the first speech vector representation.

2. The audio processing apparatus of claim 1, wherein the first audio transformation model comprises a neural network.

3. The audio processing apparatus of claim 1, wherein the instructions are operable, when executed by the at least one processor, to further cause the audio processing apparatus to:
prior to inputting the one or more audio segments to the first audio transformation model, extract the one or more words spoken by the first speaking entity from the one or more audio segments and convert the one or more words into a computer-readable format.

4. The audio processing apparatus of claim 1, wherein the first audio transformation model is configured to generate the first speech vector representation based on one or more speech primitives associated with the one or more words spoken by the first speaking entity and the one or more respective contextual attributes associated with the one or more words.

5. The audio processing apparatus of claim 1, wherein the one or more respective contextual attributes comprise at least one of one or more acoustic features, one or more emotive qualities, or one or more speech delivery characteristics associated with the one or more words spoken by the first speaking entity.

6. The audio processing apparatus of claim 5, wherein the one or more acoustic features comprise at least one of pitch, articulation, volume, or intensity.

7. The audio processing apparatus of claim 5, wherein the one or more speech delivery characteristics comprise at least one of pause duration, pace, or speech rate.

8. The audio processing apparatus of claim 5, wherein the one or more emotive qualities are characterized by one or more respective emotional dimensions, wherein the one or more respective emotional dimensions comprise at least one of valence, activation, or dominance.

9. The audio processing apparatus of claim 1, wherein the first speech vector representation and the first voice vector representation are configured for regeneration of the one or more first speech signals associated with the first speaking entity by a second audio processing apparatus.

10. The audio processing apparatus of claim 1, wherein the instructions are further operable to cause the audio processing apparatus to:
transmit, in near real-time, the audio signals captured by the one or more audio capture devices to a second audio processing apparatus for outputting of the audio signals by the second audio processing apparatus.

11. The audio processing apparatus of claim 10, wherein the audio signals are configured for generating, at the second audio processing apparatus, a live text transcript representative of the one or more first speech signals associated with the first speaking entity.

12. The audio processing apparatus of claim 11, wherein the live text transcript is configured for regeneration of the one or more first speech signals associated with the first speaking entity at the second audio processing apparatus, and wherein the regeneration of the one or more first speech signals is executed at the second audio processing apparatus simultaneously with the outputting of the audio signals by the second audio processing apparatus.

13. The audio processing apparatus of claim 1, wherein the one or more audio segments correspond to a predetermined duration of time.

14. The audio processing apparatus of claim 1, wherein the instructions are further operable to cause the audio processing apparatus to:
encrypt both the first voice vector representation and the first speech vector representation.

15. The audio processing apparatus of claim 1, wherein the instructions are further operable to cause the audio processing apparatus to:
compress at least one of the first speech vector representation or the first voice vector representation.

16. The audio processing apparatus of claim 1, wherein the instructions are further operable to cause the audio processing apparatus to:
capture, via one or more video or image capture devices, one or more portions of image data, wherein the one or more portions of image data are associated with the first speaking entity.

17. The audio processing apparatus of claim 16, wherein the first voice vector representation associated with the first speaking entity is generated based on capturing the one or more portions of image data associated with the first speaking entity.

18. The audio processing apparatus of claim 1, wherein the first audio transformation model is further configured to generate one or more portions of audio localization data associated with the first speaking entity, wherein the one or more portions of audio localization data comprises an estimated location of the first speaking entity relative to the audio processing apparatus.

19. The audio processing apparatus of claim 18, wherein the first voice vector representation associated with the first speaking entity is generated based on the audio localization data.

20. The audio processing apparatus of claim 1, wherein the instructions are further operable to cause the audio processing apparatus to:
receive a second voice vector representation;
receive a second speech vector representation;
input the second voice vector representation and the second speech vector representation into a second audio transformation model;
generate, based on the second voice vector representation, the second speech vector representation, and model output generated by the second audio transformation model, one or more second speech signals; and
output the one or more second speech signals in a second speaking voice associated with a second speaking entity related to the second voice vector representation.

21-23. (canceled)
